(19) United States
(12) Patent Application Publication
(10) Pub. No.: US 2009/0085905 A1
(43) Pub. Date: Apr. 2, 2009

(54) GAMMA-VOLTAGE GENERATION DEVICE AND LIQUID CRYSTAL DISPLAY DEVICE

(75) Inventors: Guangliang Shang, Beijing (CN); Yanfeng Wang, Beijing (CN); Changlin Leng, Beijing (CN); Liang Zhang, Beijing (CN)

Correspondence Address: LADAS & PARRY, 5670 WILSHIRE BOULEVARD, SUITE 2100, LOS ANGELES, CA, 90036-5679, US

(73) Assignee: BEIJING BOE OPTOELECTRONICS TECHNOLOGY CO., LTD., Beijing (CN)

(21) Appl. No.: 12/126,431

(22) Filed: May 23, 2008

(30) Foreign Application Priority Data
Sep. 29, 2007 (CN) CN200710175486.2

(51) Int. Cl. G06F 3/038; G09G 3/36

(52) U.S. Cl. 345/212; 345/99

(57) ABSTRACT

The present invention relates to a Gamma-voltage generation device and a Liquid Crystal Display (LCD) device, wherein the Gamma-voltage generation device comprises: a voltage series generation unit for generating a plurality of groups of voltage series; and a multi-path selection unit for selecting one voltage value from each group of voltage series, respectively, according to a voltage selection signal and outputting the same to generate a needed Gamma-voltage series. The LCD device comprises a display panel, a row driver and a column driver, a timing controller, an image analyzing and processing unit, and a Gamma-voltage series generation device. The present invention achieves dynamic Gamma-voltage generation by choosing among a plurality of groups of voltages to output the needed Gamma-voltage series. Further, the plurality of groups of Gamma-voltage series could be obtained with resistor networks and such devices in the existing art as DAC and the like are unnecessary, thereby the response rate is improved and the cost is reduced.

### TECHNICAL FIELD

The present invention relates to a Gamma-voltage generation device, and in particular, relates to a device capable of generating dynamic Gamma-voltage series and a Liquid Crystal Display device having the same.

### DESCRIPTION OF THE RELATED ART

In such fields as photography, video, computer graphics and so on, Gamma function reflects nonlinear relationship between brightness of generated images and an input data, and determines reproduction quality of the images. An existing Gamma-voltage generation circuit, as shown in FIG. 1A, generates needed reference Gamma-voltages by a group of resistors. However, the disadvantage of this circuit lies in that only a group of fixed Gamma-voltage series can be generated, and a dynamic Gamma can not be achieved.

In the Liquid Crystal Display (LCD) field, in order to improve image quality, a dynamic Gamma function is applied to LCD device in the existing art, that is, better display quality could be achieved by Gamma correction function. Some other techniques are also present in the existing art for realizing a dynamic Gamma-voltage. For example, Chinese patent application CN1251481C disclosed a programmable Gamma circuit and display device; Chinese patent application CN1773330A disclosed a dynamic Gamma adjusting circuit and method and a LCD device. The fundamental principle thereof is shown in FIG. 1B. This method for Gamma-voltage generation mainly comprises obtaining needed Gamma-voltage values by programming, and converting the same into analog voltages with a Digital to Analog Converter (DAC) for outputting. The disadvantages of the existing techniques for the dynamic Gamma-voltage generation lie in: cost for various modules, such as DACs, buffers and so on, is high, and time required for digital to analog converting is long and thereby degrading response rate.

### SUMMARY OF THE INVENTION

The problem to be resolved by the present invention is to generate dynamic Gamma-voltages without employing expensive modules such as DAC and the like.

To resolve the above problem, an embodiment of the present invention is to provide a Gamma-voltage generation device, comprising:

a voltage series generation unit, for generating a plurality of groups of voltage series; and

a multi-path selection unit, for selecting one voltage value from each of the groups of voltage series, respectively, according to a voltage selection signal and outputting the same so as to generate a needed Gamma-voltage series.

In order to resolve the above problem, an embodiment of the present invention provides a liquid crystal display device, comprising a display panel, a row driver and a column driver for driving the display panel, and a timing controller for performing timing control for the row driver and the column driver, wherein further comprising:

an image analyzing and processing unit, for analyzing and processing image data to be displayed, sending a processed image signal to the timing controller, and generating a voltage selection signal; and

a Gamma-voltage series generation device, for generating a plurality of groups of Gamma-voltage series, selecting one voltage value from each of the group of Gamma-voltage series, respectively, according to the voltage selection signal from the image analyzing and processing unit to form a needed Gamma-voltage series and output the same to the column driver.

The present invention achieves the dynamic Gamma-voltage generation by choosing among a plurality of groups of voltages and outputting a needed Gamma-voltage series. Further, the plurality of groups of Gamma-voltage series can be obtained with resistor networks and such devices in the existing art as DAC and the like are unnecessary, thereby the response rate is improved and the cost is reduced.

The detailed description for the technical solution of the present invention will be made by making reference to the following embodiments and the accompanying drawings.

### BRIEF DESCRIPTION OF THE DRAWINGS

FIG. 1A is a diagram illustrating an existing Gamma-voltage generation circuit;

FIG. 1B is a schematic diagram illustrating the structure of the existing dynamic Gamma-voltage generation device;

FIG. 2 is a schematic diagram illustrating a structure of a Gamma-voltage generation device according to an Embodiment 1 of the present invention;

FIG. 3A is a schematic diagram illustrating ideal Gamma curves according to the Embodiment 1 of the present invention;

FIG. 3B is a schematic diagram illustrating V-T curves of a LCD panel according to the Embodiment 1 of the present invention;

FIG. 4A is a schematic diagram illustrating a structure of a voltage series generation unit employing series resistor network according to the Embodiment 1 of the present invention;

FIG. 4B is a schematic diagram illustrating the circuit structure of the series resistor network shown in FIG. 4A;

FIG. 5A is a schematic diagram illustrating a structure of a voltage series generation unit employing series and parallel resistor network according to the Embodiment 1 of the present invention;

FIG. 5B is a schematic diagram illustrating the circuit structure of the series and parallel resistor network shown in FIG. 5A;

FIG. 6A is a schematic diagram illustrating a structure of a multi-path selection unit according to the Embodiment 1 of the present invention;

FIG. 6B is a schematic diagram illustrating the circuit structure of the multi-path selection unit shown in FIG. 6A; and

FIG. 7 is a schematic diagram illustrating a structure of a LCD device according to an Embodiment 2 of the present invention.

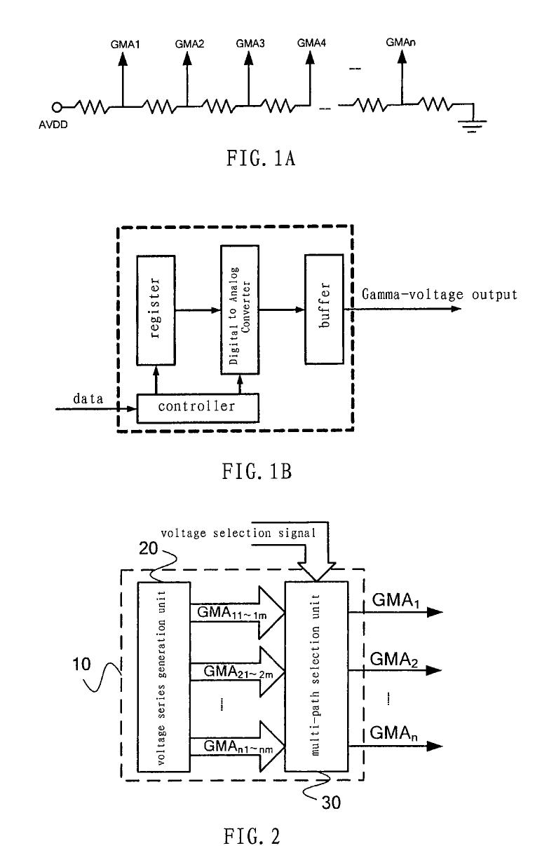

### DETAILED DESCRIPTION OF EXEMPLARY EMBODIMENTS

Unless indicated otherwise, throughout the application documents of the present application, terminologies “a”, “an”, and “the” refer to “one or a plurality of” and similarly, the component/element/means/module/unit/device and the like described in a single form herein refer to “one or a plurality of such component/element/means/module/unit/device and the like” and vice versa. Unless indicated otherwise, terminologies “include”, “comprise” and “contain” and their variants refer to “comprise but not limit to” throughout the application documents of the present application. Unless indicated otherwise, terminologies “an embodiment”, “the embodiment”, “embodiments”, “the embodiments”, “present embodiment”, “present embodiments”, “one or more embodiments” and “some embodiments” refer to one or more (but not all) embodiments throughout the application documents of the present application.

### Embodiment 1

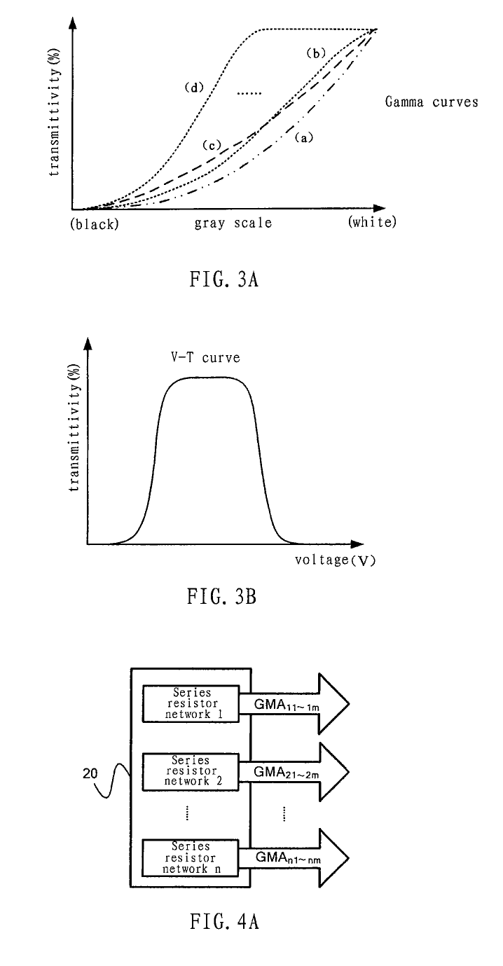

This embodiment provides a Gamma-voltage generation device. As shown in FIG. 2, the Gamma-voltage generation device 10 comprises: a voltage series generation unit 20 and a multi-path selection unit 30.

Wherein, the voltage series generation unit 20 is used to generate multiple groups of Gamma-voltage series. In particular, the voltage series generation unit 20 may comprise a plurality of resistor networks such as a resistor network 1, a resistor network 2 and so on, each of which is used to generate one or more groups of voltage series. In all the drawings, n is number of the voltage values of each the Gamma-voltage series, which is an even value such as 10, 12 and the like and can be determined according to a design requirement; m is number of Gamma curves, which is more than or equal to 2 and can be determined according to for a design requirement too. In FIG. 2, a first group of voltages series generated by the resistor network is expressed by GMA₁₁₋₁ₘ; a second group of voltages series is expressed by GMA₂₁₋₂ₘ; similarly to the rest, so a n-th group of voltages series is expressed by GMAₙ₁₋ₙₘ. Each voltage value in the Gamma-voltage series may be one key point composing the Gamma-voltage curves. The resistor network is previously configured according to needed Gamma-voltage curves, so that multiple groups of voltage values on the Gamma-voltage curves, i.e. the Gamma-voltage series, can be outputted to be available for selection. In particular, respective voltage values in the Gamma-voltage series may be determined according to the ideal Gamma curves in FIG. 3A and the V-T curves of the LCD panel in FIG. 3B. FIGS. 3A and 3B reflect corresponding relationships between gray scale and transmittivity, and between voltage and transmittivity, respectively. For example, there are multiple ideal Gamma curves (a), (b), (c) and (d) in FIG. 3A. If one of those Gamma curves is desired, a corresponding transmittivity can be calculated from the gray scale according to FIG. 3A; and then a corresponding voltage value can be calculated from the corresponding transmittivity according to FIG. 3B. Assuming that n/2 key points are chosen on the Gamma curve, those key points are corresponding to n voltage outputs of the Gamma-voltage series generation device 10, respectively, due to one transmittivity value being corresponding to two voltage values in FIG. 3B; furthermore, assuming that m (≧2) Gamma curves exist, which are corresponding to certain n voltage values selected from m voltage values generated by each resistor network.

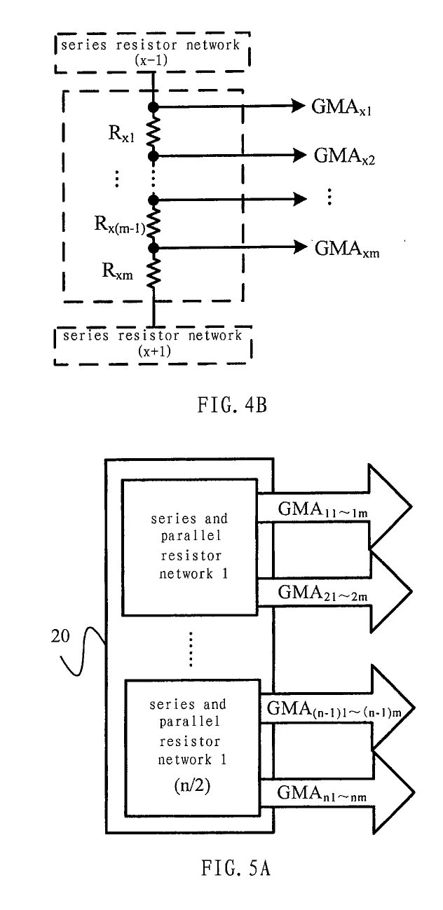

The respective resistor networks in the voltage series generation unit 20 may be a series resistor network or a series and parallel resistor network. In particular, as shown in FIG. 4A, the voltage series generation unit 20 comprises n series resistor networks such as a series resistor network 1, a series resistor network 2 and the like, each of which generates m values of a certain point GMAₓ in a Gamma-voltage series, wherein x indicates a x-th resistor network among the n resistor networks. For example, as shown in FIG. 4B, it is a schematic diagram illustrating a circuit of the series resistor network x (1<x<n) shown in FIG. 4A. Voltage division is realized by m series resistors such as Resistor Rₓ₁, Rₓ₂, and so on; output pins are connected to coupling terminals of every two of the resistors for outputting m voltage values such as GMAₓ₁, GMAₓ₂, and so on. It should be noticed that if it is a first series resistor network, the upper terminal thereof is connected to power supply AVDD; and if it is a n-th series resistor network, namely, the last one, the lower terminal thereof is connected to ground GND.

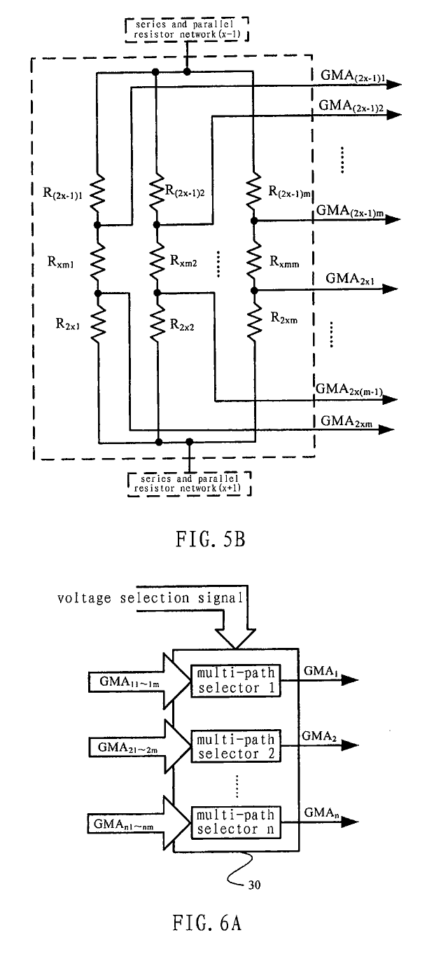

Further, as shown in FIG. 5A, the voltage series generation unit 20 comprises n/2 series and parallel resistor networks such as a series and parallel resistor network 1 and the like, each of which generates two groups of Gamma-voltages each with m values. For example, as shown in FIG. 5B, it is a schematic diagram illustrating a circuit of the series and parallel resistor network x shown in FIG. 5A. Wherein, three resistors R₍₂ₓ₋₁₎₁, Rₓₘ₁, and R₂ₓ₁ are connected in series to form a first series arm; similarly, R₍₂ₓ₋₁₎₂, Rₓₘ₂, and R₂ₓ₂ are connected in series to form a second series arm; similarly to the rest, R₍₂ₓ₋₁₎ₘ, Rₓₘₘ, and R₂ₓₘ are connected in series to form a m-th series arm. Wherein, output pins are connected to the coupling terminals of every two of the resistors for outputting a (2x-1)-th group of voltages and a 2x-th group of voltages, each having m values. The above series arms are connected in parallel to form a series and parallel resistor network. Similar to the series resistor network, if it is a first series and parallel resistor network, the upper terminal thereof is connected to power supply AVDD; and if it is a n/2-th series and parallel resistor network, i.e. the last one, the lower terminal thereof is connected to ground GND. It should be noticed here that a series arm formed by three resistors being connected in series is the most fundamental unit in the above series and parallel resistor network, and a series arm formed by five or seven or even more resistors being connected in series can achieve equivalent result with that of multiple series and parallel resistor networks being combined together. Therefore, the related details are omitted herein.

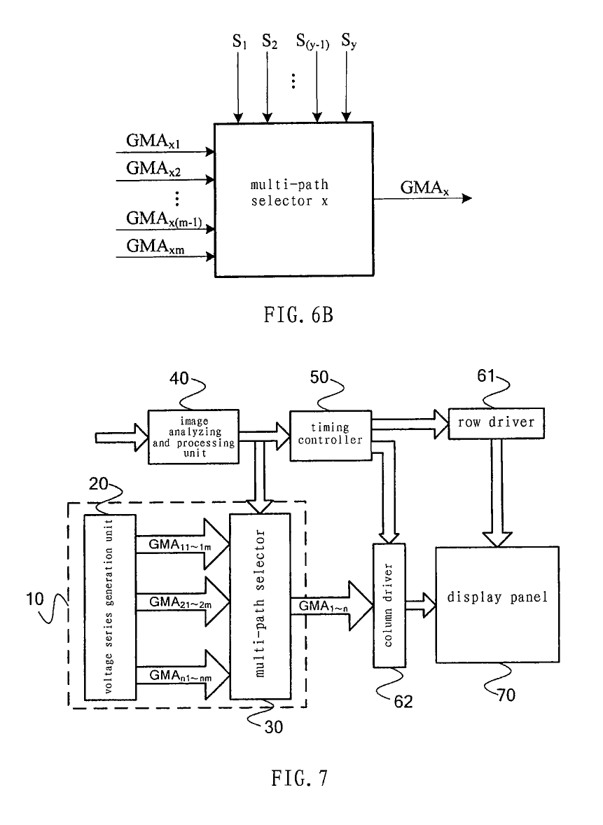

In FIG. 2A, voltage groups generated by the voltage series generation unit 20 are outputted to the multi-path selection unit 30; the multi-path selection unit 30 selects according to a voltage selection signal one voltage value from each of the voltage groups, respectively, to output, and generates the needed Gamma-voltage series. In particular, as shown in FIG. 6A, the multi-path selection unit 30 comprises n multi-path selectors such as a multi-path selector 1, a multi-path selector 2 and the like. A voltage selection signal S_{1-y} is from a image analyzing and processing unit 40, wherein y is number of the selection signals and is determined based on 2^{(y-1)}<m≦2^{y}. For example, as shown in FIG. 6B, it is a schematic diagram illustrating a circuit of a multi-path selector x shown in FIG. 6A. Wherein, GMAₓ₁₋ₓₘ is a m-th group of voltage outputs from the voltage series generation unit 20, S_{1-y} is a voltage selection signal from the image analyzing and processing unit 40, and a output GMAₓ is a x-th value of the Gamma-voltage series and is determined based on S_{1-y}.

It should be noticed that if a key point on two or more Gamma curves is overlapped, namely, an intersection point exists in different Gamma-voltage series, the above described series resistor network or series and parallel resistor network could be simplified on the corresponding points according to actual requirements. For example, when a key point of two Gamma curves is overlapped, output of this point can be provided from the same point of the resistor network, thereby reducing the number of the resistors and simplifying the resistor networks. All other cases in which a point/points are overlapped can be addressed in the same way. In addition, if a certain point is identical for all the Gamma-voltage series, not only the resistor networks can be simplified therein, but also the multi-path selection unit on this point can be omitted. The related details are omitted herein.

The device according to the present embodiment achieves generating dynamic Gamma-voltages by selecting among the generated multiple groups of voltages to output the needed Gamma-voltage series. Further, the multiple groups of Gamma-voltage series can be obtained with the resistor networks and such devices in the existing art as DAC and the like are unnecessary, thereby the response rate is improved and the cost is reduced.

### Embodiment 2

The present embodiment provides a Liquid Crystal Display (LCD) device, comprising a display panel 70, a row driver 61 and a column driver 62 for driving the display panel 70, and a timing controller 50 for performing timing control for the row driver 61 and the column driver 62. The LCD device also comprises therein an image analyzing and processing unit 40, and a Gamma-voltage generation device 10 as described in Embodiment 1. The operation principle of this LCD device is as follows:

The image analyzing and processing unit 40 analyzes and processes image data to be displayed, generates a voltage selection signal and sends it to the Gamma-voltage generation device 10; the Gamma-voltage generation device 10 generates multiple groups of Gamma-voltage series, and selects one voltage value from each group of Gamma-voltage series, respectively, according to the voltage selection signal from the image analyzing and processing unit 40, in order to generate the needed Gamma-voltage series and output the same to the column driver 62. In particular, as shown in FIG. 7, voltage values GMA₁, are outputted to the column driver 62. Wherein, the column driver 62 is connected to a source of a transistor in the display panel 70 and used to drive data lines; and the row driver 61 is connected to a gate of a transistor in the display panel 70 and used to drive selection lines.

In addition, the image analyzing and processing unit 40 also sends the processed image signal to the timing controller 50; the timing controller 50 performs driving control for the row driver 61 and the column driver 62 so as to display corresponding images.

By means of the device according to the present embodiment, since the Gamma-voltage generation device described in Embodiment 1 is employed, the dynamic Gamma-voltage generation is achieved by multi-path selection without such devices in the existing art as DAC and the like, thereby the response rate is improved and the cost is reduced.

Finally, it should be noticed that the above embodiments is only used to illustrate the technical solution of the present invention but not limit the same. While the invention has been shown and described with reference to the foregoing embodiment, it will be understood by those skilled in the art that: modifications may be made for the technical solution set forth by each of foregoing embodiments, or equivalent alternations may be made for parts of the technical features therein, while these modifications and alternations do not intend to make the essential of corresponding technical solution depart from the spirit and scope of the technical solutions of each embodiments of the present invention.

1. A Gamma-voltage generation device, characterized in comprising:
a voltage series generation unit for generating a plurality of groups of voltage series; and
a multi-path selection unit for selecting one voltage value from each group of voltage series, respectively, according to a voltage selection signal and outputting the same so as to generate a needed Gamma-voltage series.

2. The Gamma-voltage generation device of claim 1, characterized in that the voltage series generation unit comprises a plurality of resistor networks, each of which is used to generate a voltage series.

3. The Gamma-voltage generation device of claim 2, characterized in that the resistor network is a series resistor network or a series and parallel resistor network.

4. The Gamma-voltage generation device of claim 3, characterized in that structure of the series resistor network is that a plurality of resistors are connected together in series, and output pins are connected to coupling terminals of every two of the resistors.

5. The Gamma-voltage generation device of claim 3, characterized in that structure of the series and parallel resistor network is that every three resistors are connected in series to form a series arm, and output pins are connected to coupling terminals of every two of the resistors; a plurality of the series arms are connected in parallel.

6. A liquid crystal display device, comprising a display panel, a row driver and a column driver for driving the display panel, and a timing controller for performing timing control for the row driver and the column driver, characterized in further comprising:
an image analyzing and processing unit for analyzing and processing image data to be displayed, sending the processed image signal to the timing controller, and generating a voltage selection signal; and
a Gamma-voltage series generation device for generating a plurality of groups of Gamma-voltage series, selecting one voltage value from each group of voltage series, respectively, according to the voltage selection signal from the image analyzing and processing unit, to form a needed Gamma-voltage series and output the same to the column driver.
